(19) United States
(12) Patent Application Publication
(10) Pub. No.: US 2017/0321860 A1
(43) Pub. Date: Nov. 9, 2017

(54) HEADLIGHT

(71) Applicant: COPLUS Inc., New Taipei City (TW)

(72) Inventor: Jacob Wu, Tainan City (TW)

(21) Appl. No.: 15/251,995

(22) Filed: Aug. 30, 2016

(30) Foreign Application Priority Data
May 5, 2016 (TW) 105113898

(51) Int. Cl. F21S 8/10

(52) U.S. Cl. CPC F21S 48/145; F21S 48/125

(57) ABSTRACT

A headlight includes a housing, a light source module, a light shielding unit and a lens. The housing defines a reflection space, and a channel in front of the reflection space. The light source module is mounted in the reflection space, and is configured to emit a light beam reflected into the channel. The light shielding unit includes a light shielding plate mounted in the channel for shielding the light beam passing through the channel to make the light beam have a cutoff line. The lens is disposed in front of the light shielding unit, and includes a main focusing portion, and a supplementary portion protruding from the main focusing portion toward the light shielding plate for guiding the light beam to an area above the cutoff line.

### CROSS-REFERENCE TO RELATED APPLICATION

This application claims priority of Taiwanese Patent Application No. 105113898, filed on May 5, 2016.

### FIELD

The disclosure relates to a headlight, and more particularly to a headlight of a vehicle.

### BACKGROUND

A conventional headlight for a vehicle is required to produce a high beam and a low beam. The way in which the beams are produced determines if a conventional headlight is classified as a multi-reflector headlight or a projector headlight. A conventional projector headlight includes an elliptic reflector, alight source located at a first focal point of the elliptic reflector, a light shielding plate located at a second focal point of the elliptic reflector, and a condenser lens (e.g., an aspheric convex lens) located at a front of the light shielding plate. The light emitted from the light source is reflected by the elliptic reflector towards the light shielding plate, which is in part shielded by the light shielding plate and focused by the condenser lens so as to define and produce a low beam cutoff line.

In some countries, safety requirements for driving dictate that the low beam produced by the projector headlight should have a clear cutoff line, and that the luminance of an area above the cutoff line should be at a certain level. However, the conventional projector headlight often cannot provide enough luminance at the area above the cutoff line, so that the low beam produced thereby may not conform with safety standards in these countries.

### SUMMARY

Therefore, an object of the disclosure is to provide a headlight that can alleviate at least one of the drawbacks of the prior art.

The headlight includes a housing, a light source module, a light shielding unit and a lens.

The housing defines a reflection space, and a channel in front of the reflection space.

The light source module is mounted in the reflection space, and is configured to emit a light beam that is to be reflected into the channel.

The light shielding unit includes a light shielding plate that is mounted in the channel for shielding the light beam passing through the channel to make the light beam have a cutoff line.

The lens is disposed on the housing in front of the light shielding unit, and includes a main focusing portion, and a supplementary portion protruding from the main focusing portion toward the light shielding plate for guiding the light beam to an area above the cutoff line.

### BRIEF DESCRIPTION OF THE DRAWINGS

Other features and advantages of the disclosure will become apparent in the following detailed description of the embodiment with reference to the accompanying drawings, of which:

FIG. 1 is an exploded perspective view of an embodiment of a headlight according to the disclosure;

FIG. 2 is a cross-sectional view of the embodiment for illustrating a light shielding plate that distributes light at low- and high-beam-mode positions;

FIG. 3 is a front-side view of the embodiment for illustrating the light shielding plate, a light source module and a lens;

FIG. 4 is a fragmentary view of the lens; and

FIG. 5 is a plot for illustrating a light distribution pattern of a low beam produced by the headlight of the embodiment.

### DETAILED DESCRIPTION

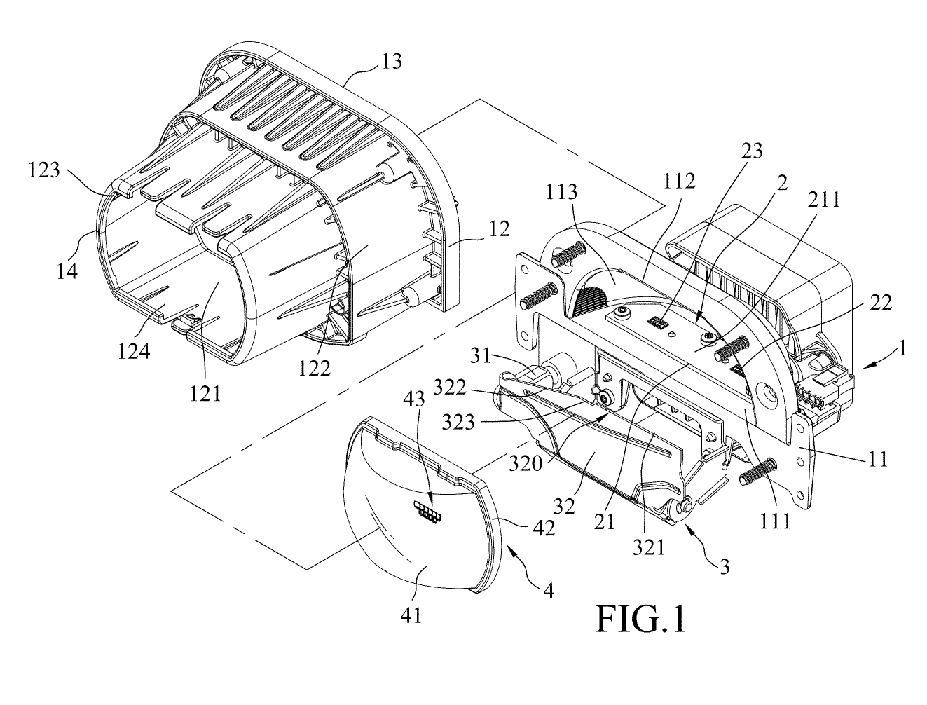

Referring to FIGS. 1-3, an embodiment of a headlight for a vehicle is illustrated. The headlight of this embodiment is exemplified by a left-side headlight, and is controlled by a circuit (not shown) to switch between a low-beam mode and a high-beam mode.

The headlight includes a housing 1, a light source module 2, a light shielding unit 3 and a lens 4 that are mounted on the housing 1.

The housing 1 includes abase 11, and a cover 12 located at a front of the base 11. The base 11 includes an installation plane 111 that is a horizontal plane facing upward, and a reflecting surface 112 that is a curved surface (e.g., an elliptic surface) extending upward and frontward from a rear edge of the installation plane 111. The installation plane 111 and the reflecting surface 112 cooperatively define a reflection space 113 facing frontward (i.e., facing the lens 4). The cover 12 defines a channel 121 in front of the reflection space 113, and has a connection end 13 that is connected to the base 11 and a distal end 14 that is opposite to the connection end 13 and that defines an opening 124 of the channel 121. In particular, the cover 12 includes a surrounding wall 122 defining the channel 121, and a ring wall 123 having the distal end 14 and extending radially and inwardly from a front edge of the surrounding wall 122. The cross-sectional area of the channel 121 shrinks gradually from the side of the connection end 13 to the side of the opening 124.

The light source module 2 is mounted in the reflection space 113, and is configured to emit a light beam that is to be reflected into the channel 121. The light source module 2 includes a circuit board 21 mounted on the installation plane 111, and a first lighting component 22 and a second lighting component 23 that are electrically connected to the circuit board 21, and that are spaced apart from each other in a left-right direction. In particular, the first and second lighting components 22 and 23 are located at opposite left and right sides of the circuit board 21. The circuit board 21 has a top plane 211 facing upward. In this embodiment, the first and second lighting components 22 and 23 are light-emitting diodes (LEDs). The number of lighting components is not limited to two, and may be different in other embodiments.

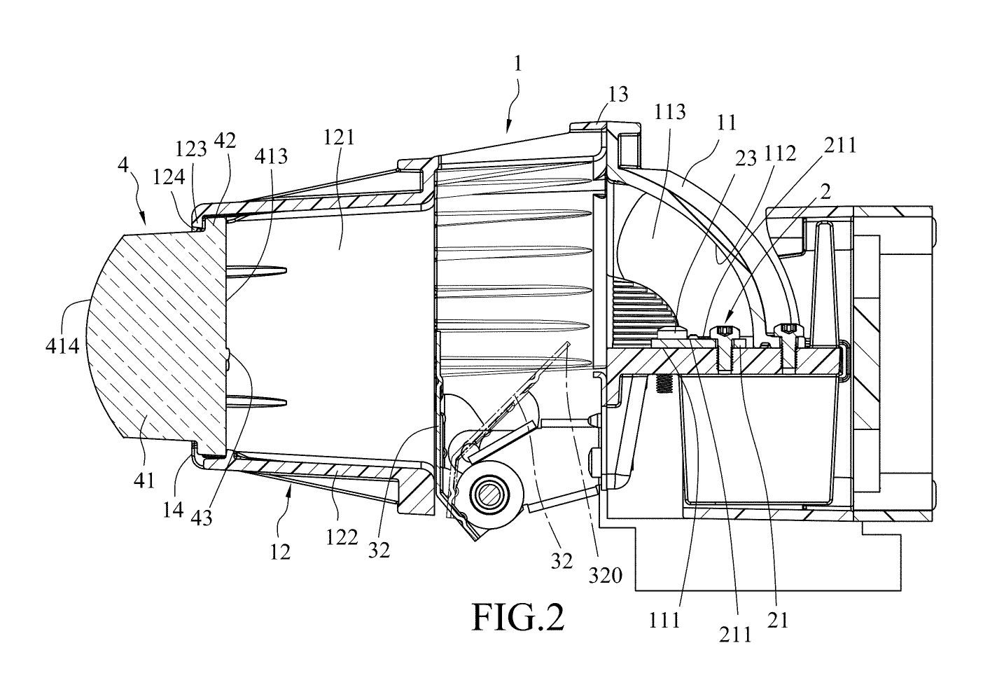

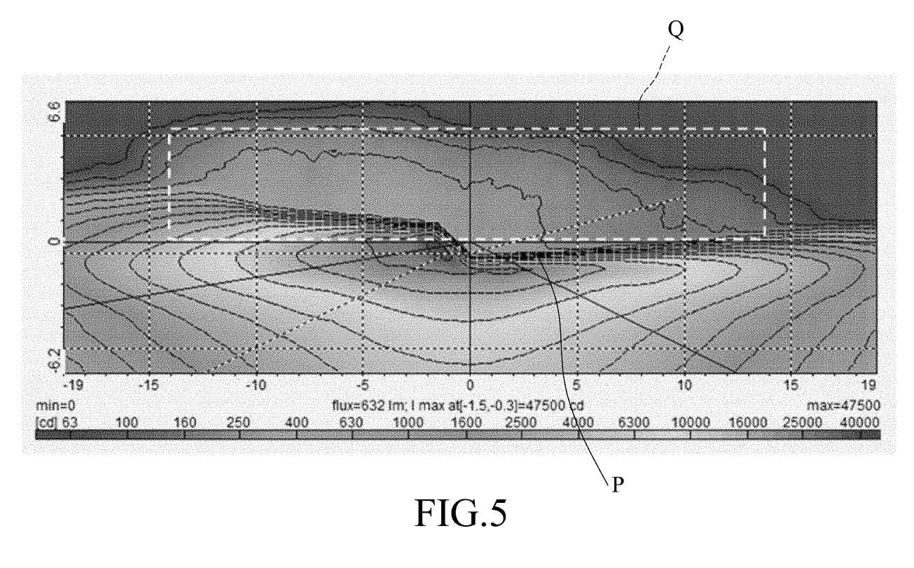

The light shielding unit 3 includes a motor 31 that is mounted to a lateral side of the base 11, and a light shielding plate 32 that is mounted in the channel 121 and near the reflection space 113 for shielding the light beam passing through the channel 121 to make the light beam have a cutoff line (P) (shown in FIG. 5). The light shielding plate 32 is driven by the motor 31 and is displaceable between a low-beam-mode position (as depicted by a solid line in FIG. 2) and a high-beam-mode position (as depicted by a dotted line in FIG. 2). The light shielding plate 32 includes a shielding edge 320 facing upward. The shielding edge 320 has a flat segment 323, and a first inclined segment 321 and a second inclined segment 322 respectively at opposite sides of the flat segment 323. The first inclined segment 321 and the flat segment 323 form a first angle 324 therebetween, and the second inclined segment 322 and the flat segment 323 form a second angle 325 therebetween that is greater than the first angle 324.

Referring to FIGS. 1-4, the lens 4 is disposed on the housing 1 in front of the light shielding unit 3, is connected to the distal end 14, and covers the opening 124. The lens 4 includes a main focusing portion 41, a ring portion 42 protruding radially and outwardly from a periphery of the main focusing portion 41, and a supplementary portion 43 protruding from the main focusing portion 41 toward the light shielding plate 32 for guiding the light beam to an area above the cutoff line (P). The main focusing portion 41 has an incident surface 413 facing the light shielding unit 3, and an exit surface 414 opposite to and spaced apart from the incident surface 413. The ring portion 42 engages the ring wall 123 of the cover 12.

The supplementary portion 43 protrudes from the incident surface 413, is formed with the main focusing portion 41 as one piece, and is below an imaginary horizontal line 411 passing through a geometric center 410 of the incident surface 413. The supplementary portion 43 is located on the incident surface 413 in a manner that a projection of a geometric central point of the supplementary portion 43 in a traveling direction of the light beam intersects an imaginary vertical line 412 passing through the geometric center 410 of the incident surface 413 and being perpendicular to the imaginary horizontal line 411.

The supplementary portion 43 includes an upper corrugated strip 431 near the horizontal line 411, and a lower corrugated strip 432 that is connected to the upper corrugated strip 431 and that is below the upper corrugated strip 431. The lower corrugated strip 432 is shorter than the upper corrugated strip 431 in a direction along the imaginary horizontal line 411.

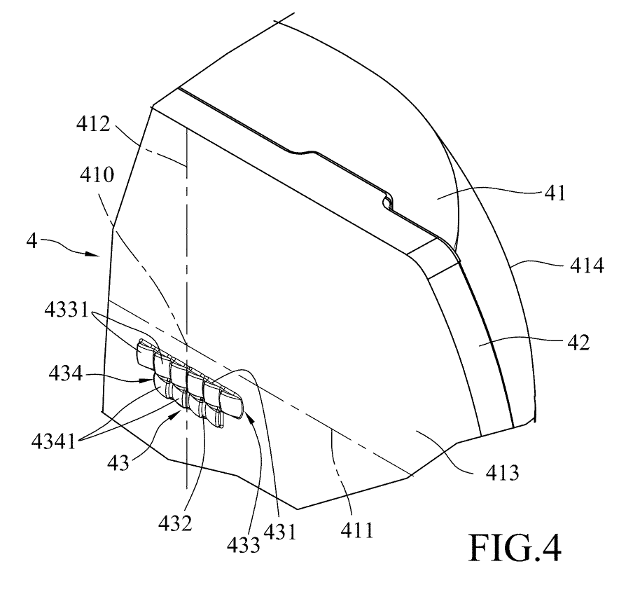

The upper corrugated strip 431 has an upper uneven surface 433 facing the light shielding unit 3, and the lower corrugated strip 432 has a lower uneven surface 434 facing the light shielding unit 3. The upper uneven surface 433 has a plurality of upper inclined surface portions 4331 facing one of a left-back direction and a right-back direction, and the lower uneven surface 434 has a plurality of lower inclined surface portions 4341 facing the other one of the left- and right-back directions. The upper inclined surface portions 4331 are equally divided into only two groups located respectively at opposite sides of the imaginary vertical line 412, and the lower inclined surface portions 4341 are equally divided into only two groups located respectively at the opposite sides of the imaginary vertical line 412. For example, in this embodiment, the upper uneven surface 433 has six upper inclined surface portions 4331 that face the right-back direction (see FIG. 4), three of which are located at a right side of the imaginary vertical line 412, and the others at a left side of the imaginary vertical line 412. Similarly, the lower uneven surface 434 has four lower inclined surface portions 4341 that face the left-back direction (see FIG. 4), two of which are located at the right side of the imaginary vertical line 412, and the others at the left side of the imaginary vertical line 412.

When in use, the headlight is user-operable to switch between the high-beam mode and the low-beam mode according to user demand. When the headlight operates in the high-beam mode, the light shielding plate 32 is at the high-beam-mode position as shown by the dotted line in FIG. 2, where the light shielding plate 32 is inclined toward the base 11, and the shielding edge 320 is lower than the imaginary horizontal line 411 as well as the first and second lighting components 22 and 23. Accordingly, the shielding edge 320 does not shield the first and second lighting components 22 and 23. Therefore, the light beam is reflected by the reflecting surface 112, passes through the channel 121, to the incident surface 413, and exits from the exit surface 414. Since the way of producing high beams is considered prior art, details thereof will be omitted herein for the sake of brevity.

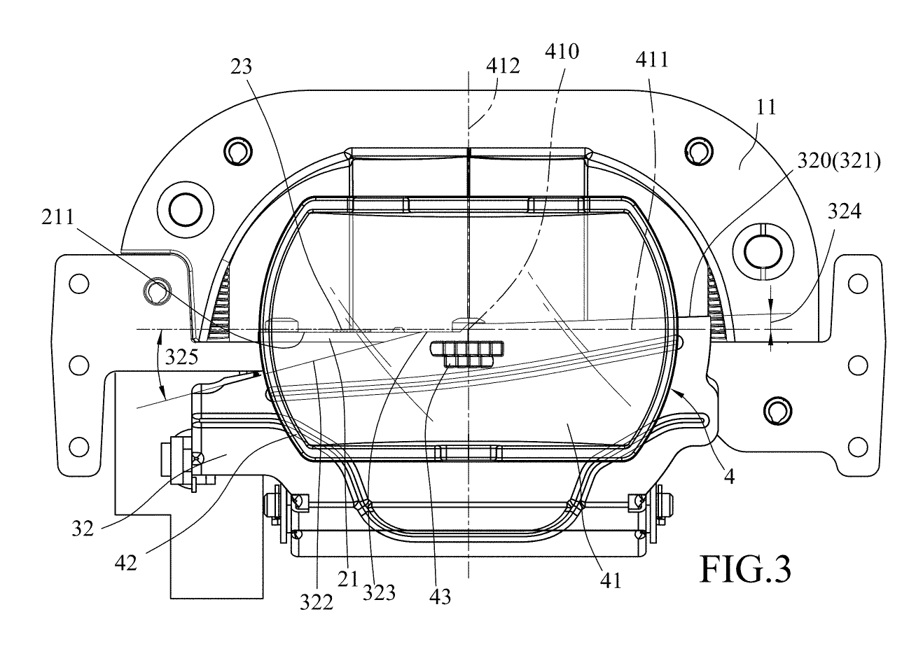

When the headlight operates in the low-beam mode, the light shielding plate 32 is rotated by the motor 31 to the low-beam-mode position as shown by the solid lines in FIGS. 2 and 3. In the low-beam-mode position, the flat segment 323 is substantially aligned with the top plane 211 of the circuit board 21 and with the imaginary horizontal line 411, the first inclined segment 321 is a little higher than the imaginary horizontal line 411 and ascends from the flat segment 323 in a direction away from the flat segment 323, and the second inclined segment 322 is lower than the imaginary horizontal line 411 and descends from the flat segment 323 in a direction away from the flat segment 323. Accordingly, when the light shielding plate 32 is at the low-beam-mode position, the first inclined segment 321 shields the first lighting component 22, and the second inclined segment 322 does not shield the second lighting component 23.

As a result, the light beam emitted from each of the first and second lighting components 22 and 23 is reflected by the reflection space 112, and passes through the channel 121 toward the lens 4. The light beam passing through the channel 121 is shielded by the first inclined segment 321 of the light shielding plate 32, such that a low-beam pattern has the cutoff line (P) that is formed sharply as shown in FIG. 5, and luminance of a lower area below the cutoff line is bright enough to satisfy safety regulations associated with the low-beam pattern in many countries. In addition, since the second inclined segment 322 is lower than the imaginary horizontal line 411, luminance of an area corresponding to the second inclined segment 322 is relatively brighter. That is to say, an area near the inside of the vehicle is relatively brighter, and satisfies the safety regulations associated with low-beam pattern.

Furthermore, besides producing the cutoff line (P) and the low-beam pattern which satisfy the safety regulations, the headlight is capable of guiding the light beam to an upper area (Q) above the cutoff line (P) via the upper and lower uneven surfaces 433 and 434, so that luminance of the upper area (Q) is enhanced. In other words, without an additional light source, the headlight according to this disclosure may enhance the luminance of the upper area (Q) above the cutoff line (P) by virtue of the supplementary portion 43 which is formed as one piece with the main focusing portion 41. Therefore, the low-beam pattern produced by the headlight according to this disclosure may satisfy the safety regulations associated with the low-beam pattern in many countries, and driving safety would be improved. Moreover, since the supplementary portion 43 and the main focusing portion 41 of the lens 4 are formed as one piece, no additional component would be required, and the manufacture and assembly of the headlight would be rather convenient.

It should be noted that, although the headlight of this embodiment is exemplified by a left-side headlight configured to be mounted on the left side of the vehicle, the headlight according to this disclosure can be configured as a right-side headlight to be mounted on the right side of the vehicle by simply modifying the light shielding plate 32. In other words, the lens 4 of the headlight according to this disclosure could be applied in both the left-side and right-side headlights to enhance the luminance of the upper area (Q) above the cutoff line (P).

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A headlight comprising:
a housing defining a reflection space and a channel in front of the reflection space;
a light source module mounted in the reflection space, and configured to emit a light beam that is to be reflected into the channel;
a light shielding unit including a light shielding plate that is mounted in the channel for shielding the light beam passing through the channel to make the light beam have a cutoff line; and
a lens disposed on said housing in front of said light shielding unit, and including a main focusing portion, and a supplementary portion protruding from said main focusing portion toward said light shielding plate for guiding the light beam to an area above the cutoff line.

2. The headlight as claimed in claim 1, wherein:
said main focusing portion of said lens has an incident surface facing said light shielding unit; and
said supplementary portion of said lens protrudes from said incident surface, and is below an imaginary horizontal line passing through a geometric center of said incident surface.

3. The headlight as claimed in claim 2, wherein said supplementary portion is located on said incident surface in a manner that a projection of a geometric central point of said supplementary portion in a traveling direction of the light beam intersects an imaginary vertical line passing through the geometric center of said incident surface and being perpendicular to the imaginary horizontal line.

4. The headlight as claimed in claim 3, wherein said supplementary portion includes an upper corrugated strip near the horizontal line, and a lower corrugated strip below said upper corrugated strip, said lower corrugated strip being shorter than said upper corrugated strip in a direction along the imaginary horizontal line.

5. The headlight as claimed in claim 4, wherein said upper corrugated strip has an upper uneven surface facing said light shielding unit, and said lower corrugated strip has a lower uneven surface facing said light shielding unit.

6. The headlight as claimed in claim 5, wherein said upper uneven surface has a plurality of upper inclined surface portions facing one of a left-back direction and a right-back direction, and said lower uneven surface has a plurality of lower inclined surface portions facing the other one of the left- and right-back directions.

7. The headlight as claimed in claim 6, wherein said upper inclined surface portions are equally divided into only two groups located respectively at opposite sides of the imaginary vertical line, and said lower inclined surface portions are equally divided into only two groups located respectively at the opposite sides of the imaginary vertical line.

8. The headlight as claimed in claim 2, wherein said supplementary portion includes an upper corrugated strip near the horizontal line, and a lower corrugated strip below said upper corrugated strip, said lower corrugated strip being shorter than said upper corrugated strip in a direction along the imaginary horizontal line.

9. The headlight as claimed in claim 8, wherein said upper corrugated strip has an upper uneven surface facing said light shielding unit, and said lower corrugated strip has a lower uneven surface facing said light shielding unit.

10. The headlight as claimed in claim 9, wherein said upper uneven surface has a plurality of upper inclined surface portions facing one of a left-back direction and a right-back direction, and said lower uneven surface has a plurality of lower inclined surface portions facing the other one of the left- and right-back directions.

11. The headlight as claimed in claim 2, wherein:
said light source module includes a circuit board, and first and second lighting components that are electrically connected to said circuit board;
said light shielding plate includes a shielding edge having a flat segment, and a first inclined segment and a second inclined segment respectively at opposite sides of said flat segment;
said light shielding plate is displaceable between
a low-beam-mode position, where said flat segment is aligned with the imaginary horizontal line, said first inclined segment is higher than the imaginary horizontal line and shields one of said first and second lighting components, and said second inclined segment is lower than the imaginary horizontal line and does not shield the other one of said first and second lighting components, and
a high-beam-mode position, where said shielding edge is lower than the imaginary horizontal line.

12. The headlight as claimed in claim 11, wherein said housing includes:
a base including an installation plane and a reflecting surface that cooperatively define the reflection space, said circuit board being mounted on said installation plane; and
a cover defining the channel, and having a connection end that is connected to said base and a distal end that is opposite to said connection end and that defines an opening of the channel, said lens being connected to said distal end and covering said opening.

13. The headlight as claimed in claim 12, wherein said main focusing portion further includes an exit surface opposite to and spaced apart from said incident surface, and said supplementary portion and said main focusing portion are formed as one piece.

14. The headlight as claimed in claim 13, wherein:
said supplementary portion is located on said incident surface in a manner that a projection of a geometric central point of said supplementary portion in a traveling direction of the light beam intersects an imaginary vertical line passing through the geometric center of said incident surface and being perpendicular to the imaginary horizontal line;
said supplementary portion includes an upper corrugated strip near the horizontal line, and a lower corrugated strip below said upper corrugated strip, said lower corrugated strip being shorter than said upper corrugated strip in a direction along the imaginary horizontal line;
said upper corrugated strip has an upper uneven surface facing said light shielding unit, and said lower corrugated strip has a lower uneven surface facing said light shielding unit;
said upper uneven surface has a plurality of upper inclined surface portions facing one of a left-back direction and a right-back direction, and said lower uneven surface has a plurality of lower inclined surface portions facing the other one of the left- and right-back directions; and
said upper inclined surface portions are equally divided into only two groups located respectively at opposite sides of the imaginary vertical line, and said lower inclined surface portions are equally divided into only two groups located respectively at the opposite sides of the imaginary vertical line.

15. The headlight as claimed in claim 1, wherein:
said light source module includes a circuit board, and first and second lighting components that are electrically connected to said circuit board;
said light shielding plate includes a shielding edge having a flat segment, and a first inclined segment and a second inclined segment respectively at opposite sides of said flat segment;
said light shielding plate is displaceable between
a low-beam-mode position, where said flat segment is aligned with the imaginary horizontal line, said first inclined segment is higher than the imaginary horizontal line and shields one of said first and second lighting components, and said second inclined segment is lower than the imaginary horizontal line and does not shield the other one of said first and second lighting components, and
a high-beam-mode position, where said shielding edge is lower than the imaginary horizontal line.

16. The headlight as claimed in claim 15, wherein said housing includes:
a base including an installation plane and a reflecting surface that cooperatively define the reflection space; and
a cover defining the channel, and having a connection end that is connected to said base and a distal end that is opposite to said connection end and that defines an opening of the channel, said lens being connected to said distal end and covering said opening.

17. The headlight as claimed in claim 16, wherein said circuit board is mounted on said installation plane.

18. The headlight as claimed in claim 16, wherein said main focusing portion includes an incident surface facing said light shielding unit, and an exit surface opposite to and spaced apart from said incident surface.

19. The headlight as claimed in claim 18, wherein said supplementary portion protrudes from said incident surface, and is formed with said main focusing portion as one piece.

20. The headlight as claimed in claim 1, wherein:
said main focusing portion includes an incident surface facing said light shielding unit, and an exit surface opposite to and spaced apart from said incident surface; and
said supplementary portion protrudes from said incident surface, and is formed with said main focusing portion as one piece.
